(19) United States
(12) Patent Application Publication
(10) Pub. No.: US 2022/0180190 A1
(43) Pub. Date: Jun. 9, 2022

(54) SYSTEMS, APPARATUSES, AND METHODS FOR ADAPTED GENERATIVE ADVERSARIAL NETWORK FOR CLASSIFICATION

(71) Applicant: Spectrm Ltd., Falkensee (DE)

(72) Inventors: Saurabh Shekhar VERMA, Falkensee (DE); Felix CORNEL, Falkensee (DE)

(73) Assignee: Spectrm Ltd., Falkensee (DE)

(21) Appl. No.: 17/479,779

(22) Filed: Sep. 20, 2021

Related U.S. Application Data
(63) Continuation of application No. PCT/IB2020/052489, filed on Mar. 18, 2020.
(60) Provisional application No. 62/819,927, filed on Mar. 18, 2019.

(51) Int. Cl. G06N 3/08

(52) U.S. Cl. CPC G06N 3/08

(57) ABSTRACT

Novel one vs. all based extensions to Generative Adversarial Networks (GANs) are disclosed, which can be applied to multiclass classification problems with changing classes in a distributed setting. GANs can be used in semi-supervised classification by providing the class label information to discriminator from real training data. Instead of using the discriminator as a label classifier, a separate network component or module—referred to as head discriminator—is appended which labels the input instances created by the generator. The discriminator is kept as a binary classifier (as in existing GANs) which only differentiates between true data and the output of the generator. The newly added head discriminator learns to discriminate between one vs all class from the generator's output. As such, it better adapts to classification problems where the number of classes and their definitions/data evolve with time, such problems being particularly difficult to handle them efficiently using traditional classification approaches and methods.

### CROSS-REFERENCE TO RELATED APPLICATIONS

This application is a continuation of International Application No. PCT/IB2020/052489, filed Mar. 18, 2020, which claims the benefit of priority to U.S. Provisional Patent Application No. 62/819,927, filed Mar. 18, 2019, the entire disclosure of each of which is hereby incorporated by reference.

This application may contain material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### TECHNICAL FIELD

Embodiments described herein generally relate to methods and systems using Generative Adversarial Networks (GANs) with unique module or component enhancement that can be used to functionally provide a solution to open world recognition problems, for example intent classification.

### BACKGROUND

In the field of computer science, artificial intelligence refers to intelligence demonstrated by machines, in contrast to the natural intelligence displayed by humans and other animals. Open world recognition presents a significant challenge to known artificial intelligence systems. Open world recognition generally refers to the ability of a system to process dynamic datasets, classify objects into known categories (also referred to herein as “classes”), recognize objects that do not match any known category, and/or match future objects/unknown data into newly identified and created novel categories. Several computer vision and Natural Language Understanding tasks are open world recognition problems.

Known artificial intelligence systems are frequently capable of evaluating or modeling data objects that fall into known categories, for example, recognizing that an image contains an object that falls into a pre-trained “horse” category or recognizing that a speech string falls into a pre-trained “request for weather forecast” category. Known artificial intelligence systems, however, are often inadequate at recognizing that an object does not match a pre-trained category and training novel categories. For example, a request about food delivery would be an out-of-class input to a system that has been trained on some pre-defined weather forecast categories, nonetheless, the request about food delivery might be falsely recognized as a pre-defined weather category and prompt an inappropriate response.

### SUMMARY

Embodiments described herein generally relate to artificial intelligence systems capable of classifying data into a known class and/or identifying data as not belonging to any known class. For example, according to embodiments described herein, a system trained on pre-defined weather forecast categories, when presented a request about food delivery can be operable to recognize that the request does not fall into any of the pre-defined weather forecast categories.

Some embodiments described herein relate to artificial intelligence techniques applicable to conversational “bots.” Known conversational bots generally struggle to recognize the intent of a user's input query. Intent classification is a major component of Natural Language Understanding (NLU) and Spoken Language Understanding tasks. Embodiments described herein are generally suitable to identify new intent classes and allow models of new intent classes to be trained independently from models of previously-known/trained intent classes.

Known Generative Adversarial Networks (GANs) architecture typically employs a generator neural network (Generator) which captures a data distribution by mapping a given noisy input similar to the known true data distribution, and a discriminative model (Discriminator) that estimates the probability that an input sample came from the true data distribution rather than the output of the generator. The Generator and the Discriminator are “adversarial” in that the Generator learns to “fool” the Discriminator, while the Discriminator learns to determine whether a data object is from the true data distribution or synthetically created by the generator. Known GANs can be configured to address classification problems with static datasets. However, many datasets are dynamic. For example, new intents may be added to a dataset associated with an intent classification problem. In dynamic datasets existing classes are being updated or removed, and new classes are being detected and added. A static dataset in NLU is unlikely, and necessarily limiting. Having a dynamic dataset, employing a single multiclass classifier approach is inefficient and infeasible, as it typically involves re-training of the classifier almost from scratch every time the dataset is changed.

Embodiments described herein provide methods, systems, and apparatuses for adapted generative adversarial networks for classification, including analyzing and training an adapted GAN with an additional module layer/network module—referred to as the Head Discriminator (HD). For each class, a Generator (G), a Discriminator (D) and a Head Discriminator are trained. The Head Discriminator provides a probability score that a given input belongs to a particular class following a one-vs-all (OvA) approach. This per-class architecture allows GANs described herein allows adapted GANs to retrain only on created and/or updated classes. Having a parallel architecture permits training of Generator, Discriminator, and Head Discriminator simultaneously and/or per-class in a distributed environment. The Discriminator can be a binary classifier configured to distinguish between the output of the Generator and true data. The Head Discriminator can be configured to distinguish between classes from the Generators output during training and classification/prediction, following an OvA approach. Such embodiments better adapt to dynamic multiclass classification problems, such as intent classification, where the number of classes, class definitions, and/or data change over time. In some embodiments, the disclosed methods are suitable to address and be applied to open world recognition problem sets with a range of dynamic fluctuations in class definitions. Thus, GANs described herein can be applied to challenges that fit into an open world recognition framework in which classification classes can be continuously and/or unpredictably updated, and/or to multiclass classification where data can be static or dynamic.

Other systems, processes, and features will become apparent upon examination of the following drawings and detailed description. It is intended that all such additional systems, processes, and features be included within this description, be within the scope of the present disclosure.

### BRIEF DESCRIPTION OF THE DRAWINGS

The drawings primarily are for illustrative purposes and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

So that the manner in which the above recited features, advantages, and objects of the present disclosure are attained and can be understood in detail, a more particular description of the disclosure, briefly summarized above, can be had by reference to the embodiments illustrated in the appended drawings.

It is to be noted, however, that the appended drawings illustrate only typical embodiments and are therefore not to be considered limiting of the scope of the disclosure, for the disclosure may admit to other equally effective embodiments.

FIG. 1 illustrates components of an example known/base GAN architecture.

FIG. 2 illustrates components of an adapted GAN architecture having a Head Discriminator, according to some embodiments.

FIG. 3 illustrates a distributed parallelized training process for a GAN with the expanded network module Head Discriminator, according to some embodiments.

FIGS. 4-8 illustrate the training process of a GAN, according to an embodiment.

FIG. 9 illustrates a novel class detector, according to an embodiment.

FIG. 10 provides results of an example of a GAN, according to an embodiment.

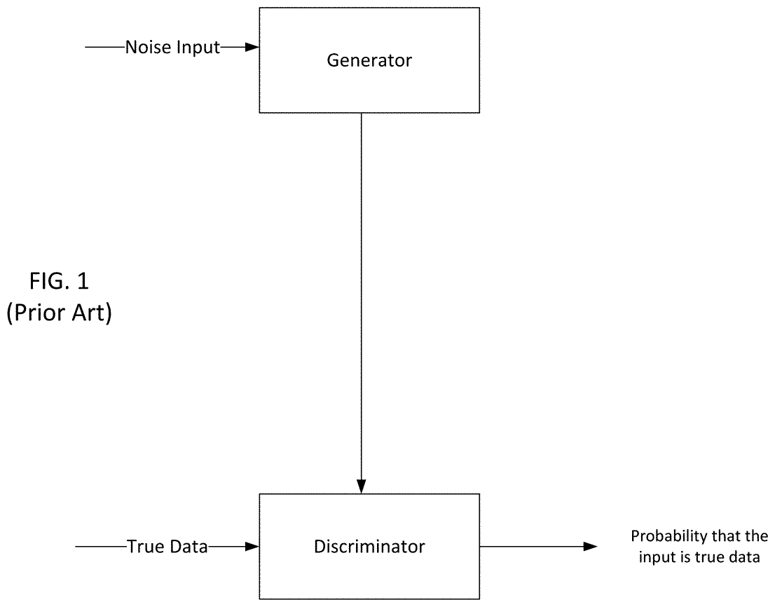

### DETAILED DESCRIPTION

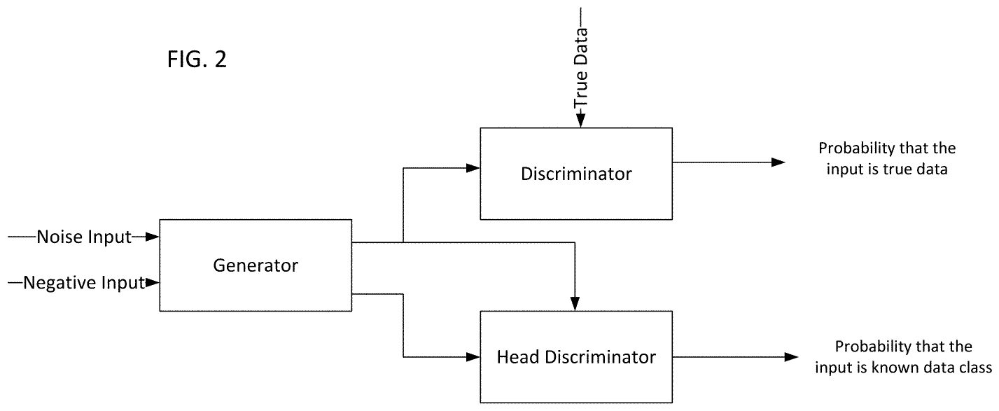

Embodiments described herein provide methods, systems, and apparatuses for adapted Generative Adversarial Network (GAN) for classification, including analyzing and training an adapted GAN with an additional module layer/network module—referred to as the Head Discriminator (HD). According to some embodiments, for each class, a Generator (G), a Discriminator (D) and a Head Discriminator are trained. FIG. 2 illustrates components of an adapted GAN architecture, according to an embodiment. The Head Discriminator is configured to provide a probability score that a given input belongs to a particular class following a one-vs-all (OvA) approach. This per class architecture allows the GAN to retrain only on created or updated classes. Having a parallel architecture permits training of Generator, the Discriminator, and/or the Head Discriminator, simultaneously and/or per-class in a distributed environment. The Discriminator can be a binary classifier configured to separate generator output from true known data. The Head Discriminator is configured to distinguish between classes from the Generators output during training and classification following OvA. Such embodiments better adapt to dynamic multiclass classification problems, such as intent classification, where the number of classes and their definitions and data change over time.

The Generator, the Discriminator, and the Head Discriminator can each be, for example, a machine learning module, neural network, and/or other computational model, stored in memory and configured to be executed on one or more processors. The Generator, the Discriminator, and the Head Discriminator can be stored in a centralized or a distributed computing environment. The Generator is communicatively coupled to the Head Discriminator and the Discriminator by any suitable network or communications link (e.g., an intranet, the internet, wired or wireless connections, etc.). The Generator, the Discriminator, and the Head Discriminator can be stored and/or executed in a common physical and/or logical computing environment or can reside on physically and/or logical separate computing entities.

According to some embodiments of the disclosure, a full flow training of the adapted GAN can occur in parallel, over a distributed environment. This per-class architecture allows the GAN to retrain only on created or updated classes. Having a parallel architecture permits training of Generator, Discriminator, and Head Discriminator simultaneously per-class, and/or in a distributed environment. Such embodiments better adapt to dynamic multiclass classification problems, such as intent classification, where the number of classes and their definitions and data change over time. Thus, GANs that include Head Discriminator(s) can be operable to accept and/or process unknown, unforeseen, and unfamiliar data.

Existing multiclass classifier approaches are not suitable for training on dynamic class datasets, because they may involve retraining of the classifier almost from scratch with changes in the data, such as adding a new class after the initial training iterations. In such approaches, emergent or dynamic data can trigger retraining on classes from unknown input, as determined by the adapted module for assessing distinctiveness of unknown inputs (e.g., the Head Discriminator). In some embodiments, a one vs. all (OvA) approach is used with the base classifier, adapted GANs. In some embodiments, the adapted module determines the probability that a given input belongs to a known class. In some embodiments, the adapted module determines the probability that the given input is distinct to no known class. In some embodiments applying an OvA approach to adapted GANs trains all classifiers in parallel, allowing training and prediction/classification of an unknown input to take place in a distributed environment. After training is completed, the input to the adapted GAN can be unknown, unforeseen, and unfamiliar, and the adapted GAN can be operable to provide a recognition functionable to determine if the unclassified input belongs or does not belong to a classified known class by assigning a probability score to it.

Open world recognition problems having multiple classes can be formally defined where K^{t}={i|0<i≤j} represents the set of labels of known classes at time t and j^{t} is the number of known classes at time t. All unknown classes are labeled as 0. Let x∈ [symbol] ^{l×d} be a feature, where l×d is the dimension of input data and y∈K^{t} a class. For this y, there is a recognition function ƒ_{y} that is measurable. The solution to an open world recognition problem dataset is a tuple [F, φ, v, L, I] such that each element of the tuple represents respectively: a multiclass open set recognition function F^{t}: [symbol] ^{l×d}→K^{t}∪{0} that can map a feature vector to a class; a vector function φ^{t}: [symbol] ^{l×d}→ [symbol] ^{m} defined as φ^{t}(x)=(ƒ₁^{t}(x), ƒ₂^{t}(x), . . . ƒₘ^{t}(x)) such that ƒ₁^{t} can be class recognition functions; a novelty detector v^{t}: [symbol] ^{l×d}→ [symbol] of which the detector can determine the distinctiveness of the input; a labeling process L: [symbol] ^{l×d}→ [symbol] ⁺ that can be applied to unknown at time t data U^{t}. Labeled data is D^{t}={(L(xⱼ), xⱼ)} for some xⱼ∈U^{t}. For k new classes, Kₜ₊₁ can be defined as K^{t}∪{m+1, . . . , m+k}; and an incremental learning function I^{t} which can update ƒ₁^{t}, . . . , ƒₘ^{t} and add ƒₘ₊₁^{t+1}, . . . ƒₘ₊ₖ^{t+1}.

A solution as defined in the previous paragraph can be supported by finding a recognition function ƒᵢ for each class i. Known GANs are generally unable to distinguish between classes or finding recognition functions for different classes. GANs described herein that include a Head Discriminator can be operable to define multiple recognition functions ƒᵢ.

According to some embodiments an adapted GANs can be used to create a chat bot which can answer questions about specific intents. The adapted GAN can be used to classify the intent of some user input (received, e.g., from a user communication device) and give an answer using a response generation component for classified class. For example an adapted GAN can be trained such that a bot can provide a weather forecast. Given the user message “Do I need my umbrella today?” the adapted GAN might classify the intent as “question about today's weather.” The chat bot might answer with the weather forecast for today by choosing a response, such as “Yes, you need an umbrella,” “It is going to rain,” or “It is rainy today” provided/selected by the response generation component. Given a question like “How high is the Eiffel tower?”, the adapted GAN can be operable to recognize that this is outside of any of its known intents. The bot then might give some default answer like asking the user to rephrase the question because it did not match any known intent.

A generator distribution p_{g} over data x can be learned by defining a prior on input noise variables p_{z}(z), and then a mapping to data space as G(z; θ_{g}) is done, where G is a differentiable function represented by a multilayer perceptron with parameters θ_{g}. Further, a second multilayer perceptron D(x; θ_{d}) is trained to discriminate between data instances sampled from the Generator and the actual training examples. The Discriminator outputs a scalar value as the probability of a data instance belonging to the given training examples. D(x) represents the probability that x comes from the training data rather than the generator p_{g}. Both the models G and D can be simultaneously trained following their optimization.

In GANs described herein that include a Head Discriminator and are operable to process multi-class and/or open world recognition data, the Generator and Discriminator keep almost the same behavior, G (z; θ_{g}) and D (x; θ_{d}). For a class i in consideration, x is the real data of the intent with probability distribution p_{data}(x), z is the real data with some noisy/augmented data with probability distribution p_{data} (z). An additional dataset x̅ represents out-of-class data and/or data from other classes (e.g., negative intents, data from all other intents). For example, in a Natural Language Understanding task, x̅ can represent language objects having other intents. x̅ represents a partial complement set of data x with probability distribution P_{data}(x̅) The data x̅ and z are also disjoint.

The Head Discriminator can be represented as HD (G (z); θ_{hd}) where HD (G (z)) represents the probability that G (z) comes from the training example rather than p_{g} (x̅). The Discriminator learns to discriminate between the probability distributions p data (x) and p_{g} (z), acting as an adversary to the Generator. The Generator not only learns to fool the Discriminator by mocking p_{g}(z)=p_{data}(x), but simultaneously also learns that p_{g}(x̅)≠p_{g} (z) through the Head Discriminator. The Head Discriminator learns to discriminate between p_{g}(x̅) and p_{g}(z).

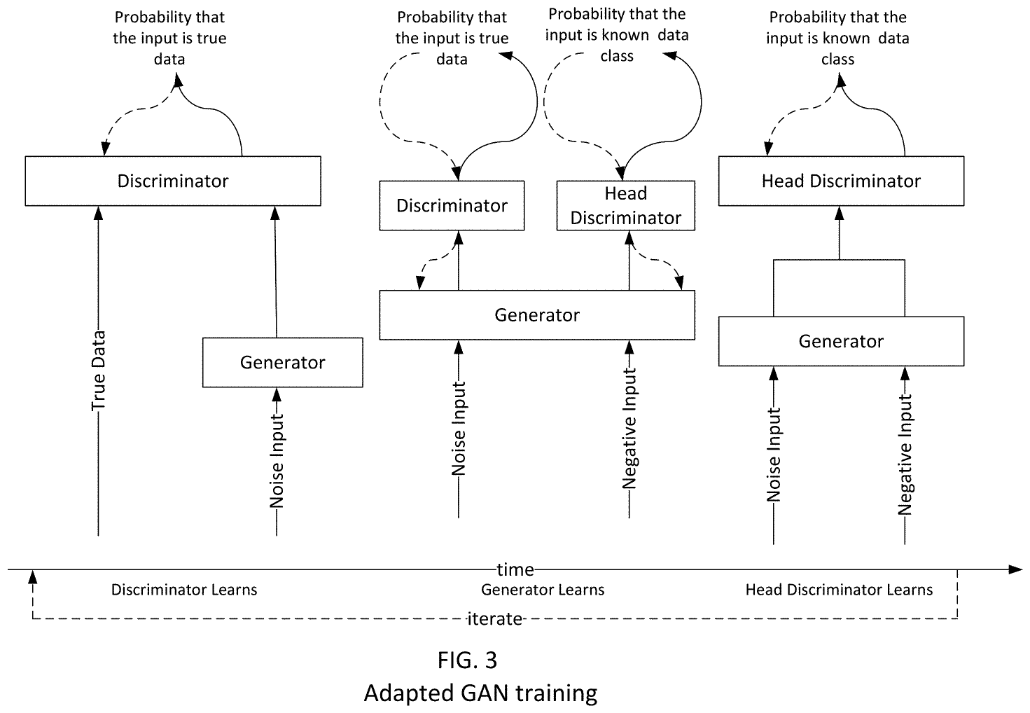

One embodiment of an iterative training flow of the adapted GAN is illustrated in FIG. 3. For every iteration, the Discriminator can be trained on true data and output of the Generator, while the Generator is fed noisy and/or augmented data. The Generator can be trained on noisy and/or augmented data and on negative data, the negative data is created by combining data from all the other known classes following OvA, and its output fed to the Discriminator and the Head Discriminator. The Head Discriminator can be trained on output from the Generator which is fed noisy and/or augmented data and negative data.

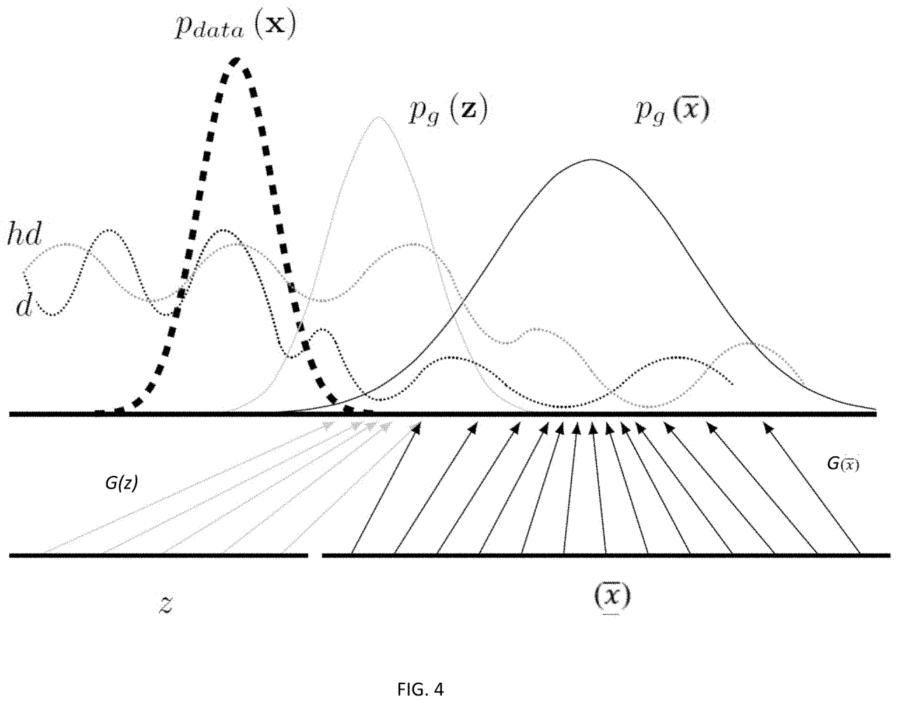

FIGS. 4-8 illustrate the training process of an adapted GAN, according to an embodiment. FIGS. 4-8 illustrate three data distributions, the “true” data distribution (p_{data} (x), the output of the Generator (p_{g} (z), and out-of-class or “negative” data (p_{g} (x̅)). Before training, as shown in FIG. 4, the Discriminator and the Head Discriminator are partially accurate classifiers, and the output of the Generator p_{g} (z) is similar to, but diverges from, the true data p_{data} (x), and the output of the Discriminator d is inaccurate. The bottom horizontal line represent the domains from which z forms part of the noisy and/or augmented data and x̅ is the negative data. The middle horizontal line represents part of the full domain data. The upward arrows indicate how the mapping G (z) and G(x̅) imposes the noisy and/or augmented data distribution and the negative data distribution p_{g} on the transformed samples.

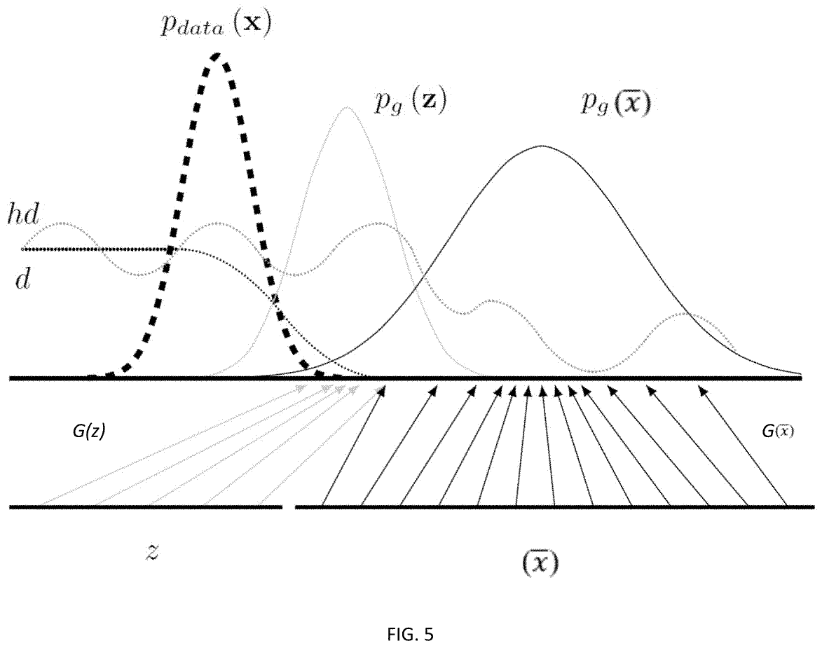

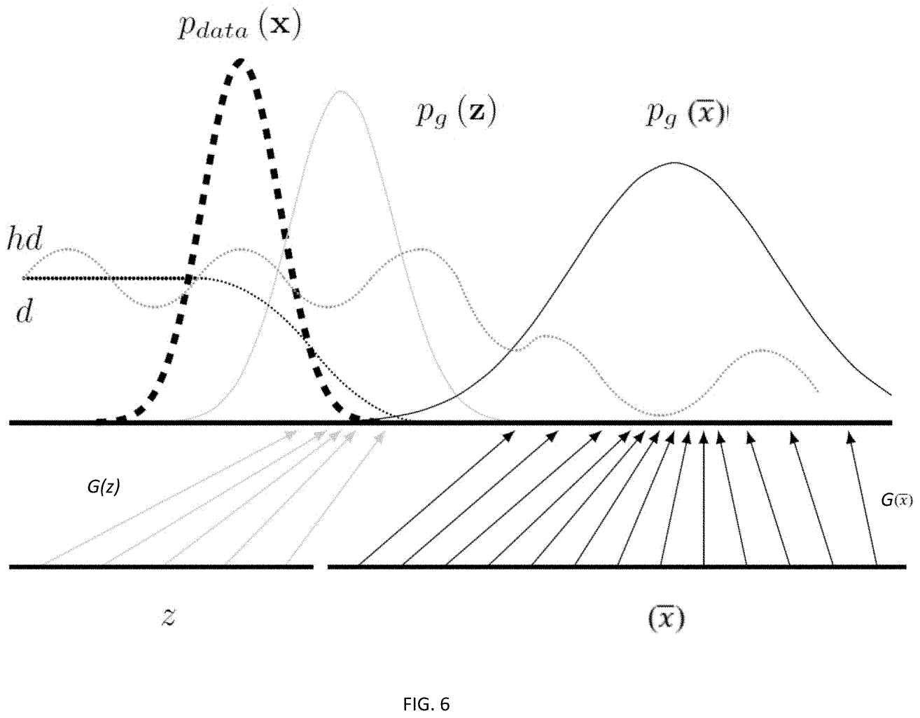

FIG. 5 illustrates a trained/retrained Discriminator, relative to FIG. 4, in which the Discriminator can be trained to discriminate samples from x and G (z). Comparing FIG. 4 to FIG. 5, output of the Discriminator d more accurately assesses the probability that a data sample is from the true distribution (p_{data}(x)). As discussed above, the Discriminator and the Generator can be trained as adversaries such that improvements in Discriminator output feeds back to improve the ability of the Generator to simulate the true data. Therefore, after an update to the Generator, the gradient of the Discriminator has guided G (z) to flow to regions that are more likely to be classified as x. Similarly stated, comparing FIG. 5 to FIG. 6 illustrates an improved Generator model, as reflected in the output of the Generator p_{g} (z) converging to the true distribution p_{data}(x).

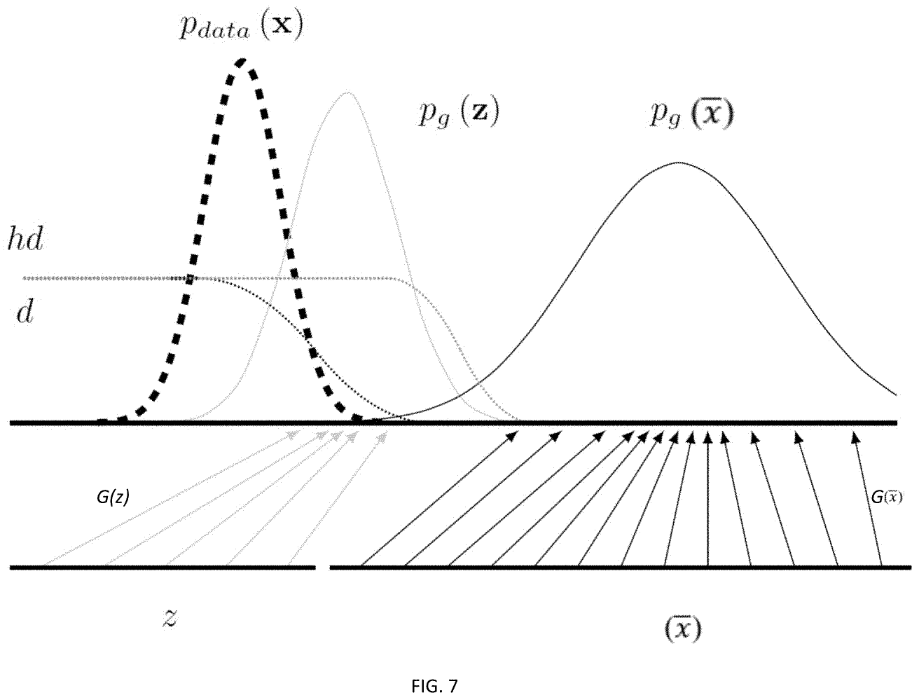

A comparison of FIG. 6 to FIG. 7 illustrates the Head Discriminator learning to distinguish between G (x̅) and G (z). The output of the Head Discriminator hd in FIG. 7 more accurately assesses the probability that a data sample is from the true distribution (P_{data}(x)) rather than a negative or out-of-class data set G (x̅).

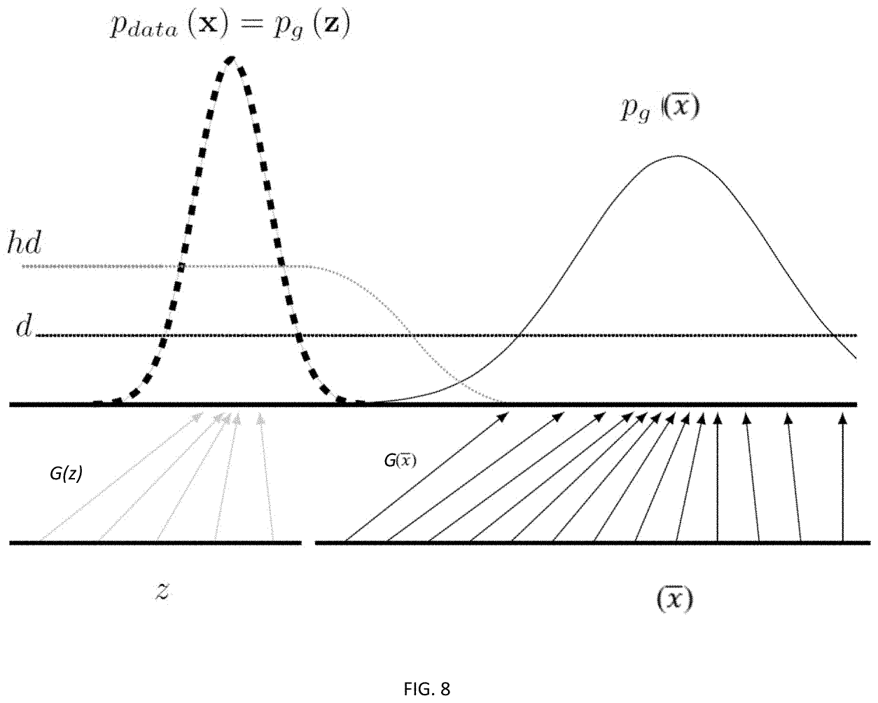

Eventually, depending on computational resources and model complexity, the Generator will no longer be able to improve on outputs, and p_{g} (z) will approach p_{data} (x). Additionally, as the Head Discriminator learns to discriminate between p_{g} (x̅) and p_{g} (z), out-of-class data will no longer be assessed by the Discriminator. As a consequence, the Discriminator will be unable to distinguish between true data and synthetic data, and the Discriminator's output d will approach ½, indicating that for any data object the probability of it being true data or synthetic data is 50%, as shown in FIG. 8.

In some embodiments, D, G, and/or HD are differentiable models or layers. In some embodiments, D, G, and/or HD are artificial neural networks (ANN). In some embodiments, D, G, and/or HD are feedforward neural networks. In some embodiments, D, and/or HD are convolutional neural networks (CNN) and G is a recurrent neural network (RNN). In some embodiments, D, and/or HD are convolutional neural networks (CNN) and G is a transformer network. In some embodiments, D, and/or HD, and G are RNN. In some embodiments, D, and/or HD are RNN and G is a transformer network. In some embodiments, D, and/or HD, and G are transformer network. In some embodiments, D, and/or HD are transformer network with classification head layer, and G is a transformer network. In some embodiments, D, and/or HD are CNN, and G is a transformer network.

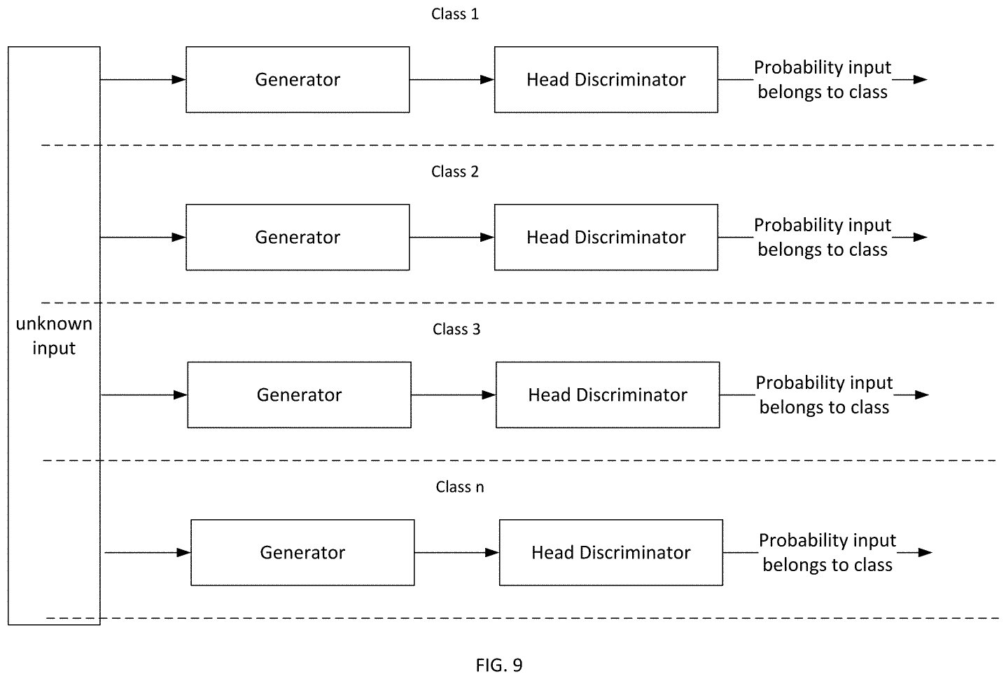

FIG. 9 illustrates a novel class detector, according to an embodiment. GANs described herein are operable to assess a data input (labeled “unknown input”) and determine whether the class of the data input is associated with a previously recognized class (for example, associated with a previously trained Generator/Discriminator pair). The data input can be fed into each previously trained Generator/Head Discriminator pairs. Each Generator/Head Discriminator pair can be associated with a different data class. In some embodiments, the data inputs class can be determined based on, for example, the Head Discriminator with the highest probability output. In an instance in which no Head Generator produces a probability value above a threshold value, a new data class can be defined manually and then training of this new class can be triggered similar previously trained classes following OvA. Also, if any change in the data is recognized for a certain class the re-training is triggered only on the previously trained tuple G, D, and HD for that class.

The following pseudo code snippet demonstrates the cycle operation of mini-batch stochastic gradient descent training of the adapted GAN, according to some embodiments. The number of steps to apply to the Discriminator, Generator, and Head Discriminator are k_{d}, k_{g}, and k_{hd}. In some embodiments, the standard gradient-based learning rule is used with momentum. In some embodiments, the gradient-based learning rule is used with weight decay. In some embodiments, the gradient-based learning rule is used with weight decay and momentum.

for number of training iterations do

for k_{d} steps do
Sample mini-batch of m noise samples {z⁽¹⁾, z⁽²⁾, . . . , z^{(m)}} from noisy data generating distribution p_{data} (z).
Sample mini-batch of m samples {x⁽¹⁾, x⁽²⁾, . . . , x^{(m)}} from data generating distribution p_{data} (x).
Update the discriminator by ascending its stochastic gradient:

$${Δ}_{{θ}_{d}} \frac{1}{m} {\sum }_{i = 1}^{m} [ log D ( {x}^{( i )} ) + log ( 1 - D ( G ( {z}^{( i )} ) ) ) ]$$

$$end for$$

$$for {k}_{g} steps do$$

Sample mini-batch of m noise samples {z⁽¹⁾, z⁽²⁾, . . . , z^{(m)}} from noisy data generating distribution p_{data} (z).
Sample mini-batch of m samples {x̅⁽¹⁾, x̅⁽²⁾, . . . x̅^{(m)}} from data generating distribution p_{data} (x̅).
Update the generator by descending its stochastic gradient:

$${Δ}_{{θ}_{g}} \frac{1}{m} {\sum }_{i = 1}^{m} [ log ( 1 - D ( G ( {z}^{( i )} ) ) ) + log ( HD ( G ( {\overline{x}}^{( i )} ) ) ) ]$$

$$end for$$

$$for {k}_{hd} steps do$$

Sample mini-batch of m noise samples {z⁽¹⁾, z⁽²⁾, . . . , z^{(m)}} from noisy data generating distribution p_{data} (z).
Sample mini-batch of m samples {x̅⁽¹⁾, x̅⁽²⁾, . . . , x̅^{(m)}} from data generating distribution p_{data} (x̅).
Update the Head Discriminator by ascending its stochastic gradient:

$${Δ}_{{θ}_{hd}} \frac{1}{m} {\sum }_{i = 1}^{m} [ log ( 1 - HD ( G ( ( {\overline{x}}^{( i )} ) ) ) + log ( HD ( G ( {z}^{( i )} ) ) ) ] \\ end for \\ end for$$

Evaluation of an example embodiment was conducted, with D and HD being Convolutional Neural Networks (CNN). A model architecture of CNN—similar to the one described by Yoon Kim (Convolutional neural networks for sentence classification. 2014. CoRR, abs/1408.5882, the entirety of which is herein expressly incorporated by reference for all purposes)—was used, while Generator is a recurrent bi-directional Long Short Term Memory (Bi-LSTM) network. The input to D is a sentence matrix where rows are word vector representations of each word/token, word2vec (see e.g., https://code.google.com/archive/p/word2vec/) pre-trained word vector representation was used (see Mikolov et al., 2013. Distributed representations of words and phrases and their compositionality. Advances in Neural Information Processing Systems 26, pages 3111-3119. Curran Associates, Inc., the entirety of which is herein expressly incorporated by reference for all purposes). In this example embodiment, G takes a full sequence of word vectors and outputs the similar dimension encoding for the input sequence. HD takes the encoded output sequence generated by G. For every intent i, a tuple of Dᵢ, Gᵢ, and HDᵢ are trained, though for final validation and prediction only Gᵢ and HDᵢ are used. The evaluation experiment was performed on TREC question dataset-task (Experimental Data for Question Classification, http://cogcomp.org/Data/QA/QC/), which involves classifying a question into 6 question types (whether the question is about a person, location, numeric information, description, entity, and abbreviations). The dataset has 5452 training examples, and a test set consisted of 500 examples, the size of vocabulary is 9592, a small part of training data is kept for validation. Table 1 shows the example embodiment compared with an existing state-of-the-art approaches, and demonstrates the ability to obtain competitive results. The SVM used by Silva et al. (2011), which has the highest score, should not be compared to other methods, as it includes n-grams, morphological and 60 hand-coded rules as features, which are problem dependent and cannot be scaled easily, in contrast with the other approaches. In the rest of the approaches, including adapted GANs, there are no hand-coded rules or other specific adjustments used other than the part of the data used as validation for creating the stopping criteria for the training and the pre-trained word vector. The example embodiment provided similar observation to Kim (2014) regarding using word vectors embeddings where fine-tuning the pre-trained embeddings outperformed randomized initialization and keeping the pre-trained static. Additional experimentation without adapted GANs were conducted where the model was trained with only discriminative training, with only one CNN without any adversarial training referred to as CNN OvA, and LSTM also without any adversarial training followed by CNN network referred to as LSTM-CNN OvA. The GAN based approach outperforms both classifiers as can be seen from Table 1.

TABLE 1

| Models | TREC |
|---|---|
| Adapted GANs of an embodiment | 93.6 |
| approach | |
| CNN OvA | 90.2 |
| LSTM-CNN OvA | 89.8 |
| CNN-non-static (e.g., Kim, 2014) | 93.6 |
| DCNN (e.g., Kalchbrenner et al., 2014) | 93 |
| SVM (e.g., Silva et al., 2011) | 95 |

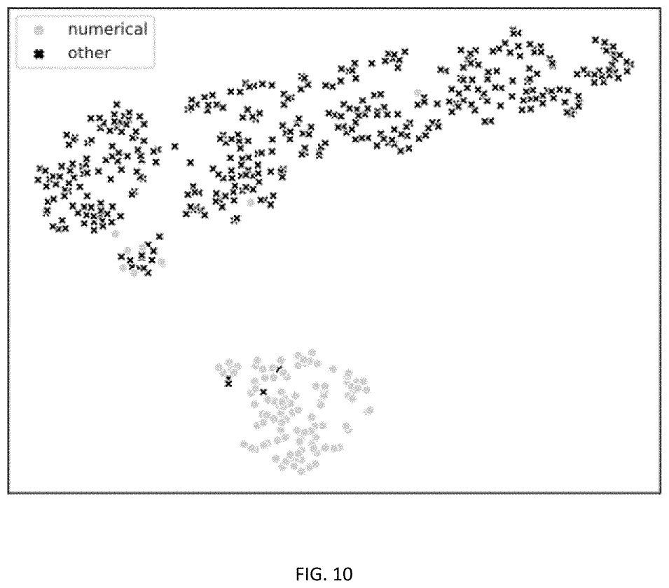

FIG. 10 shows a TSNE plot visualizing the Generator's output distribution of the last encoded vector for all examples in test data, and it can be seen in FIG. 10 that the generator manages to generate encodings for real data and negative data which are easier to be differentiated. In the TSNE plot in FIG. 10 the gray data points are the questions about numeric values, and the black data points are the rest of the other classes.

The disclosed advancements to GANs architecture demonstrate the benefits and use as a classifier, obtaining competitive results with current state-of-the-art on TREC data. Experiments demonstrate the Generator learns to generate different probability distribution conditioned on real data and negative data. While shown with a dataset related to intent classification, the approach can be applied to any classification problem. The disclosure provides a powerful approach to generate the data distribution over which a discriminative model can be trained.

The disclosed approach, using a GAN with Head Discriminator, is able to predict responses to user input that is relevant and responsive to user input.

Some embodiments of the disclosure include an entity recognition component that is configured to break a sentence into different parts to abstract it. The parts here are called entities. Entities can be, by way of non-limiting example, locations, persons, organizations, and/or the like. Some embodiments of the disclosure include a semantic parser component that makes connections between entities by analyzing the semantic structure of a sentence. Some embodiments of the disclosure include a sentiment analytics component. Some studies estimate that 80% of communication in a given conversation is non-verbal. For chat bots and the like, such issues are confounded because sentiment is difficult to assess in written communication. The sentiment analytics component can abstract the usage of certain words (or images, emojis, etc.) and then calculate a score to decide whether the usage is “positive” or “negative”.

While the foregoing is directed to embodiments of the present disclosure, other and further embodiments of the invention can be devised without departing from the basic scope thereof.

The above-described embodiments can be implemented in any of numerous ways. For example, embodiments can be implemented using hardware, software (e.g., executed or stored in hardware) or a combination thereof. When implemented in software, the software code can be executed on any suitable processor or collection of processors, whether provided in a single computer or distributed among multiple computers.

Further, it should be appreciated that a computer can be embodied in any of a number of forms, such as a rack-mounted computer, a desktop computer, a laptop computer, or a tablet computer. Additionally, a computer can be embedded in a device not generally regarded as a computer but with suitable processing capabilities, including a Personal Digital Assistant (PDA), a smart phone or any other suitable portable or fixed electronic device.

Also, a computer can have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer can receive input information through speech recognition or in other audible format.

Such computers can be interconnected by one or more networks in any suitable form, including a local area network or a wide area network, such as an enterprise network, and intelligent network (IN) or the Internet. Such networks can be based on any suitable technology and can operate according to any suitable protocol and can include wireless networks, wired networks or fiber optic networks.

The various methods or processes outlined herein can be coded as software that is executable on one or more processors that employ any one of a variety of operating systems or platforms. Additionally, such software can be written using any of a number of suitable programming languages and/or programming or scripting tools, and also can be compiled as executable machine language code or intermediate code that is executed on a framework or virtual machine.

Also, various above-described concepts can be embodied as one or more methods, of which an example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments.

All publications, patent applications, patents, and other references mentioned herein are incorporated by reference in their entirety for all purposes, including the following:
Martin Arjovsky, Soumith Chintala, and Leon Bottou. Wasserstein GAN. CoRR, abs/1701.07875, 2017.
Abhijit Bendale and Terrance Boult. Towards open world recognition. In The IEEE Conference on Computer Vision and Pattern Recognition (CVPR), June 2015.
Ian Goodfellow, Jean Pouget-Abadie, Mehdi Mirza, Bing Xu, David Warde-Farley, Sherjil Ozair, Aaron Courville, and Yoshua Bengio. Generative adversarial nets. pages 2672-2680, 2014.
Xufeng Han and Alexander C Berg. Dcmsvm: Distributed parallel training for single-machine multiclass classifiers. In Computer Vision and Pattern Recognition (CVPR), 2012 IEEE Conference on, pages 3554-3561. IEEE, 2012.
Ronan Collobert, Jason Weston, Leon Bottou, Michael Karlen, Koray Kavukcuoglu, and Pavel P. Kuksa. 2011. Natural language processing (almost) from scratch. CoRR, abs/1103.0398.
Alex Graves. 2013. Generating sequences with recurrent neural networks. CoRR, abs/1308.0850.
Patrick Haffner, Gokhan Tur, and Jerry H. Wright. Optimizing svms for complex call classification. Acoustics, Speech, and Signal Processing, 1988. ICASSP-88, 1988 International Conference on, 10 2003.
Yoon Kim. 2014. Convolutional neural networks for sentence classification. CoRR, abs/1408.5882.
Xin Li and Dan Roth. 2002. Learning question classifiers. In Proceedings of the 19th International Conference on Computational Linguistics—Volume 1, COLING '02, pages 1-7, Stroudsburg, Pa., USA. Association for Computational Linguistics.
Geoffre Hinton Laurens van der Maaten. 2008. Visualizing data using t-sne. The Journal of Machine Learning Research, 9:85.
Tomas Mikolov, Ilya Sutskever, Kai Chen, Greg S Corrado, and Jeff Dean. 2013. Distributed representations of words and phrases and their compositionality. In C. J. C.
Burges, L. Bottou, M. Welling, Z. Ghahramani, and K. Q. Weinberger, editors, Advances in Neural Information Processing Systems 26, pages 3111-3119. Curran Associates, Inc.
Alec Radford, Luke Metz, and Soumith Chintala. 2015. Unsupervised representation learning with deep convolutional generative adversarial networks. CoRR, abs/1511.06434.
Ruhi Sarikaya, Geoffrey E. Hinton, and Anoop Deoras.2014. Application of deep belief networks for natural language understanding. IEEE/ACM Trans.Audio, Speech & Language Processing, 22(4):778-784.
Phillip Isola, Jun-Yan Zhu, Tinghui Zhou, and Alexei A Efros. Image-to-image translation with conditional adversarial networks. In IEEE Conference on Computer Vision and Pattern Recognition, 2017.
Alec Radford, Luke Metz, and Soumith Chintala. Unsupervised representation learning with deep convolutional generative adversarial networks. CoRR, abs/1511.06434, 2015.
Ruhi Sarikaya, Geoffrey E. Hinton, and Anoop Deoras. Application of deep belief networks for natural language understanding. IEEE/ACM Trans. Audio, Speech & Language Processing, 22(4):778-784, 2014.
Jost Tobias Springenberg. Unsupervised and semi-supervised learning with categorical generative adversarial networks. arXiv preprint arXiv:1511.06390, 2015.
Robert E. Schapire and Yoram Singer. Boostexter: A boosting—based system for text categorization. Machine Learning, 39(2):135-168, May 2000.
Joao Silva, Luisa Coheur, Ana Cristina Mendes, and Andreas Wichert. 2011. From symbolic to sub symbolic information in question classification. Artif. Intell. Rev., 35(2): 137-154.
Jun-Yan Zhu, Taesung Park, Phillip Isola, and Alexei A Efros. Unpaired image-to-image translation using cycle-consistent adversarial networks. In Computer Vision (ICCV), 2017 IEEE International Conference on, 2017.
Xiaodong Zhang and Houfeng Wang. A joint model of intent de-termination and slot filling for spoken language understanding. In Proceedings of the Twenty-Fifth International Joint Conference on Artificial Intelligence, IJCAI'16, pages 2993-2999. AAAI Press, 2016.
Ashish Vaswani, Noam Shazeer, Niki Parmar, Jakob Uszkoreit, Llion Jones, Aidan N. Gomez, Lukasz Kaiser, and Illia Polosukhin. 2017. Attention is all you need. CoRR abs/1706.03762

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of” or “exactly one of.” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system, comprising:
an adapted generative adversarial network (GAN) configured for classification, the adapted GAN including a Generator, a Discriminator, and a Head Discriminator layer,
the adapted GAN configured to, for each class, train the Generator, the Discriminator, and the Head Discriminator layer, the Head Discriminator layer is configured to provide a probability score that a given input belongs to that class following a one-vs-all (OvA) model;
the adapted GAN configured to retrain upon determination of a created or updated class.

2. The system of claim 1, wherein the adapted GAN is configured such that the Generator, the Discriminator, and Head Discriminator are trained simultaneously, in parallel, on a per-class basis in a distributed environment.

3. The system of claim 1, wherein the adapted GAN is configured such that the Generator and Head Discriminator can be used simultaneously and in parallel to at least one of classify and/or predict unknown data on a per-class basis in a distributed environment.

4. The system of claim 1, wherein:
the Discriminator is configured as a binary classifier during training to separate an output of the Generator from true known data; and
the Head Discriminator is configured to discriminate between classes from the output of the Generator during training and classification.

5. (canceled)

6. The system of claim 1, wherein the Discriminator includes a feedforward neural network.

7.-8. (canceled)

9. The system of claim 1, wherein the Discriminator includes a plurality of recurrent neural networks.

10. The system of claim 1, wherein the Discriminator includes a classification head layer.

11. (canceled)

12. The system of claim 1, wherein the Head Discriminator includes a feedforward neural network.

13. (canceled)

14. The system of claim 1, wherein the Head Discriminator includes a recurrent convolutional neural network.

15. (canceled)

16. The system of claim 1, wherein the Head Discriminator includes a transformer having a classification head.

17. (canceled)

18. The system of claim 1, wherein the Head Discriminator includes a convolutional neural network.

19. (canceled)

20. The system of claim 1, wherein the Generator includes a feedforward neural network.

21. The system of claim 1, wherein the Generator includes a recurrent neural network.

22. The system of claim 1, wherein the Generator includes a transformer.

23. A method, comprising:
training an adapted generative adversarial network (GAN) having a Generator, a Discriminator, and a Head Discriminator layer, on a per-class basis such that for each class, the Head Discriminator layer is configured to provide a probability score that a given input belongs to that class following a one-vs-all (OvA) model;
retraining the adapted GAN upon a determination of a created or updated class; and
classifying the given input.

24. The method of claim 23, further comprising iteratively training the Discriminator on true data and output of the Generator, the input to the Generator being at least one of noisy data or augmented data.

25. The method of claim 23, further comprising:
training the Generator on: (1) at least one of noisy data or augmented data and (2) negative data; and
providing the output of the Generator as input to Discriminator and the Head Discriminator.

26. The method of claim 23, further comprising training the Head Discriminator on output from the Generator when the Generator is provided (1) at least one of noisy data or augmented data and (2) negative data.

27. The method of claim 23, wherein the adapted GAN is trained for intent classification.

28. A method, comprising:
classifying via an adapted generative adversarial network (GAN) having a Generator, a Discriminator, and a Head Discriminator, the classification including:
analyzing and training the adapted GAN with a Head Discriminator layer, including:
for each class, training the Generator, the Discriminator, and the Head Discriminator, the Head Discriminator configured to provide\ a probability score that an input belongs to that class following a one-vs-all (OvA) approach.

29. A non-transitory computer-readable storage medium storing instructions, which when executed by a computer system, perform operations for processing data, the instructions comprising instructions to:
receive a user communication from a user device;
apply, by a response generation component of the at least one server, an adapted GAN to the user communication to generate an optimal generated response to the user communication, the GAN including a Generator, a Discriminator, and a Head Discriminator;
generate a plurality of responses responsive to the user communication using the adapted GAN;
select a response from the plurality of responses; and
transmit the response selected from the plurality of responses to the user device.
